(19) United States
(12) Patent Application Publication
(10) Pub. No.: US 2008/0172413 A1
(43) Pub. Date: Jul. 17, 2008

(54) MOBILE MULTIMEDIA CONTENT DISTRIBUTION AND ACCESS

(76) Inventor: Fu-Sheng CHIU, Taipei city (TW)

Correspondence Address: SINORICA, LLC, 528 FALLSGROVE DRIVE, ROCKVILLE, MD, 20850, US

(21) Appl. No.: 11/623,053

(22) Filed: Jan. 12, 2007

(51) Int. Cl. G06F 17/30

(52) U.S. Cl. 707/104.1

(57) ABSTRACT

A method for distributing and accessing multimedia content by a portable electronic device comprising a list of metatags hyperlinking multimedia content associated with the metatags is disclosed. A user can select a metatag and a list of multimedia content associated with the selected metatag is displayed. A thumbnail and relevant media information is provided for each media file. When a user selects content from the list the multimedia is played. A search function is provided to allow users to search for content. The search results are displayed in a list with a thumbnail and media information for each entry. An upload function is provided to allow users to upload multimedia files. The size and color of each metatag indicates the amount of content associated with the tag. The position of the metatag in the list indicates the number of views.

### BACKGROUND OF THE INVENTION

1. Field of the Invention

The present invention relates to mobile communications. More specifically, the present invention provides a method of mobile multimedia content distribution and access that utilizes a window of metatags for easy access to media.

2. Description of the Prior Art

Internet users are able to interact or view a wide variety of information on their desktop computer. The desktop computer typically includes a large monitor for displaying the information. The monitors usually have a minimum display size of 15 inches measured diagonally bottom left corner to top right corner. 17 inch and 19 inch monitors are also common.

When accessing the information a user navigates through a number of menus and the user makes various selections from the menu options. On a desktop computer although time-consuming the navigation is somewhat straightforward since the display is large.

However, if a user of a mobile electronic device wishes to interact with the information, their attempt is thwarted as the display screen of the mobile device is very small. For example, a cellular phone has only a few inches of display area. Navigating through numerous menus is complex and frustrating. As a result, users of mobile electronic devices are unable to enjoy interacting with Internet information.

Therefore, there is need for an efficient and effective method of accessing and distributing content for mobile electronic devices that eliminates the complex navigation method in order to allow users to easily interact with Internet content.

### SUMMARY OF THE INVENTION

To achieve these and other advantages and in order to overcome the disadvantages of the conventional method in accordance with the purpose of the invention as embodied and broadly described herein, the present invention provides an efficient and effective method of distributing and accessing multimedia content using a mobile or portable electronic device.

After a registered user connects to the content provider's server, the present invention presents a screen that displays a scrollable list of metatags. The metatags are hyperlinks associated with content that are relevant to the text of the metatags.

The size and color of each tag indicates the amount of content associated with the tag. The more content associated with the metatag, the larger the tag font is displayed. Also, the color of large content metatags is a different color than small content metatags. This allows users to quickly locate metatags with a large amount of content.

The ranking or position of the metatag indicates the number of views or popularity of the content associated with the metatag. The most popular or most viewed metatag content is located at the first position of the metatag list. The second most viewed is positioned second, and so on.

The user selects the metatag that they are interested in and a screen appears displaying a list of available multimedia content that is associated with the metatag. A thumbnail or screen shot of the multimedia content is displayed in a scrollable list. Additional information such as title, date created, upload user name, number of views, or other data related to the multimedia is displayed next to each thumbnail. The list of multimedia content can be sorted according to any of the information.

The main page displaying the list of metatags also provides a search function with a search text box allowing users to input search terms and search for multimedia content associated with the search terms. After searching, a page is displayed similar to the above mentioned screen displaying available multimedia content but now displaying the search results. This screen displays a thumbnail and additional information for each multimedia contained in the search results.

An upload option is also provided on the main page which allows the user to upload multimedia that is stored on their portable device. After selecting the upload option a file browsing window is displayed and the user selects the file to be uploaded. The user selects at least one metatag to be associated with the file and the file is uploaded to the user's account. The uploaded file is now available for other users to view.

The user selects the content that they wish to view and a player screen automatically opens and plays the multimedia. The player screen provides player controls such as play, pause, fast forward, rewind, stop, next, previous, and save. The player controls allow the user to interact with the multimedia. A progress bar is displayed showing the progress or how much of the content has been viewed and how much of the content is left. The progress bar allows the user to jump to a particular section of the content. A timer also displays how much time has expired and how much time is left.

The player screen also displays information associated with the current multimedia. For example, the information comprises title, user name, author, rating, or ranking. A rating option allows the user to vote or rate the multimedia. The average rating is displayed which is compiled from the total votes.

Additionally, a play all option is displayed on the multimedia list screen. This allows the user to automatically play all multimedia content that are shown in the list.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings:

FIG. 1 is a diagram illustrating a main screen displaying metatags associated with multimedia content according to an embodiment of the present invention;

FIG. 2A is a diagram illustrating a multimedia content list screen with thumbnails according to an embodiment of the present invention;

FIG. 2B is a diagram illustrating a search results list screen with thumbnails according to an embodiment of the present invention;

FIG. 3 is a diagram illustrating a multimedia player window according to an embodiment of the present invention;

FIG. 4 is a diagram illustrating a file upload screen according to an embodiment of the present invention;

FIG. 5 is a flowchart illustrating a method for distributing multimedia content according to an embodiment of the present invention;

FIG. 6 is a flowchart illustrating a method for accessing multimedia content according to an embodiment of the present invention;

FIG. 7 is a flowchart illustrating a method for searching multimedia content according to an embodiment of the present invention; and

FIG. 8 is a flowchart illustrating a method for uploading multimedia content according to an embodiment of the present invention.

### DESCRIPTION OF THE PREFERRED EMBODIMENTS

Reference will now be made in detail to the preferred embodiments of the present invention, examples of which are illustrated in the accompanying drawings. Wherever possible, the same reference numbers are used in the drawings and the description to refer to the same or like parts.

A content provider first sets up a multimedia content server which comprises a plurality of multimedia content. A user registers with the content provider in order to access the multimedia. Once the user is registered the user logs onto the multimedia content server. In one embodiment of the present invention the user provides their user name and password in order to complete the log in process.

In another embodiment the log in process is automatic. In the automatic log in embodiment the user simply selects to access the service and the user's mobile electronic device automatically negotiates with the multimedia content server to gain access. The mobile device supplies information that identifies the individual user, for example, user identification, user name, account information, password, license information, device identification, biometric information, a cookie, or information stored in a cookie.

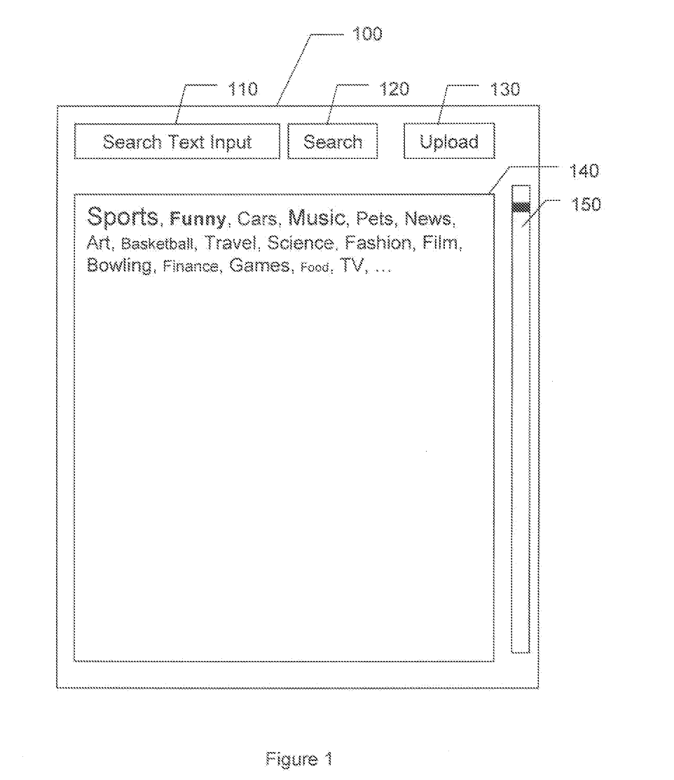

Refer to FIG. 1, which is a diagram illustrating a main screen displaying metatags associated with multimedia content according to an embodiment of the present invention.

After the user has successfully connected to the content server, the main screen 100 as illustrated in FIG. 1 is shown in the display of the mobile electronic device. The main screen 100 comprises a metatag list section 140, a search icon 120, a search text input section 110, and an upload icon 130. The search input 110 allows users to input text in order to search for multimedia content relevant to the search terms. By selecting the upload icon 130 users can upload multimedia content that they have stored on their portable device.

The metatag list section 140 comprises a list of metatags that are hyperlinks to multimedia content relevant to the text of the metatag. A vertical scrollbar 150 is provided to allow users to scroll through the list.

The size and color of each metatag indicates the amount of content associated with the tag. The more content associated with the metatag, the larger the tag font is displayed. Also, the color of large content metatags is a different color than small content metatags. This allows users to quickly locate metatags with a large amount of content.

In FIG. 1, the text of the metatag “Sports” is a larger font than many of the others, for example the metatag “Food”. This indicates that there is more multimedia content associated with the metatag “Sports” than there is content associated with the metatag “Food”. This allows users to quickly locate more multimedia content.

The ranking or position of the metatag indicates the number of views or popularity of the content associated with the metatag. The most popular or most viewed metatag content is located at the first position of the metatag list. The second most viewed is positioned second, and so on.

In an embodiment of the present invention the position of the metatag indicates the number of times the content has been viewed. In another embodiment of the present invention the position of the metatag indicates the number of times the metatag has been selected. In another embodiment of the present invention the position of the metatag in the list indicates the ranking or rating that other users have rated the content.

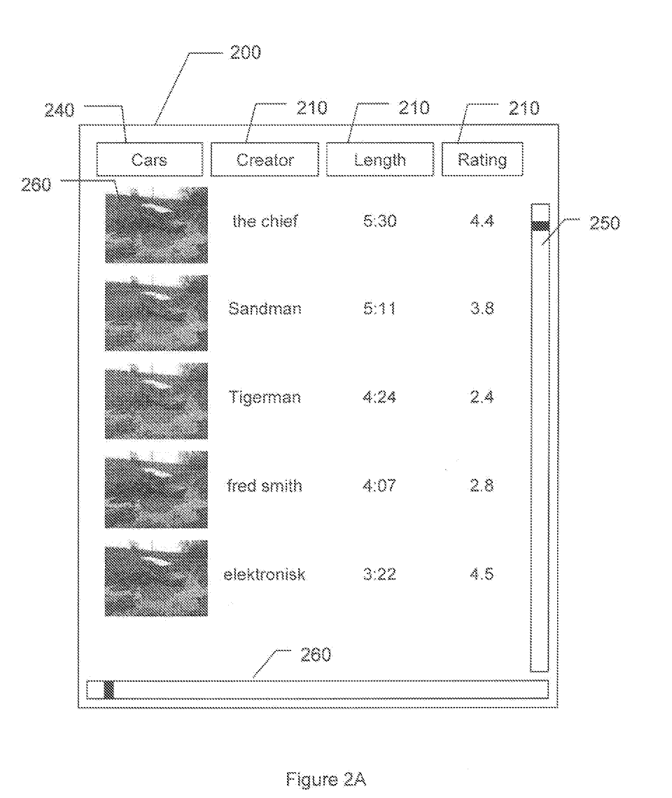

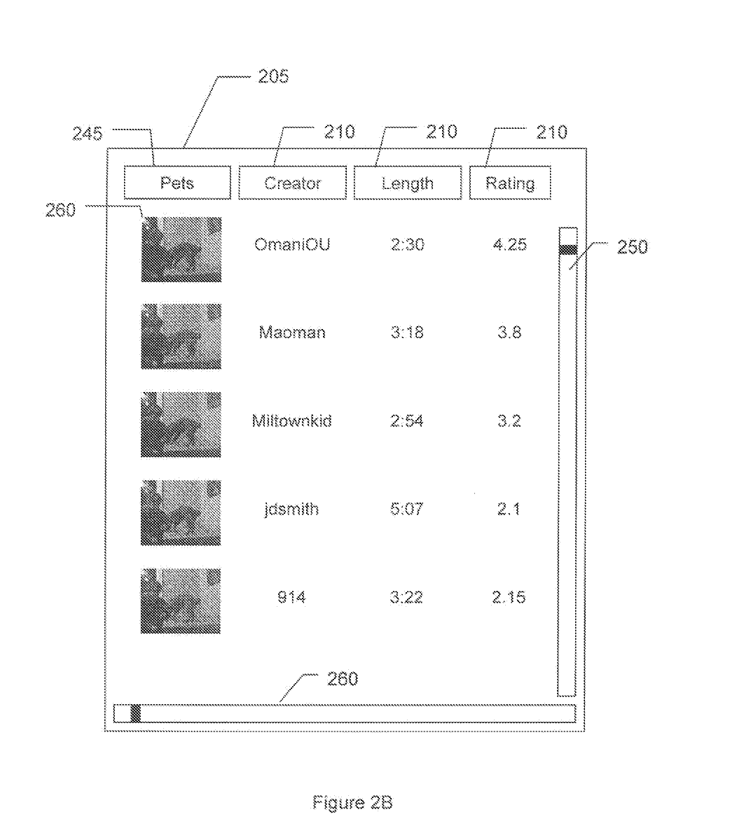

Refer to FIG. 2A, which is a diagram illustrating a multimedia content list screen with thumbnails according to an embodiment of the present invention.

The user selects the metatag that they are interested in from the main screen and a multimedia content screen 200 appears displaying a list of available multimedia content that is associated with the metatag. The selected metatag 240 is displayed for the user's reference. In FIG. 2A the selected metatag is Cars. A thumbnail 260 or screen shot of the multimedia content is displayed in a list that is scrollable using a vertical scrollbar 250 and a horizontal scrollbar 260. Additional information 210 such as title, date created, upload user name, number of views, or other data related to the multimedia is displayed next to each thumbnail 260 or below each thumbnail. The list of multimedia content can be sorted according to any of the information categories. For example, the list can be sorted by the name of the user who uploaded the multimedia. This allows users to quickly locate all media supplied by a particular user. In FIG. 2A the multimedia content list is sorted by the length of the multimedia content. Since the list of multimedia content is scrollable vertically, horizontally, or in both directions, the amount of content or information displayed is virtually unlimited.

The main screen 100 in FIG. 1 displaying the list of metatags 140 also provides a search function 120 with a search text box 110 allowing users to input search terms and search for multimedia content associated with the search terms.

Refer to FIG. 2B, which is a diagram illustrating a search results list screen with thumbnails according to an embodiment of the present invention.

After searching, a search results page 205 is displayed similar to the multimedia content list of FIG. 2A displaying available multimedia content but now displaying the search results. This screen displays a thumbnail 260 and additional information 210 for each multimedia contained in the search results. This screen is similar to the multimedia list screen described above and functions in the same manner. In FIG. 2B the content is sorted by rating. The search term used 245 is displayed for the user's reference.

In FIG. 1 an upload option 130 is also provided on the main page 100 which allows the user to upload multimedia that is stored on their portable device.

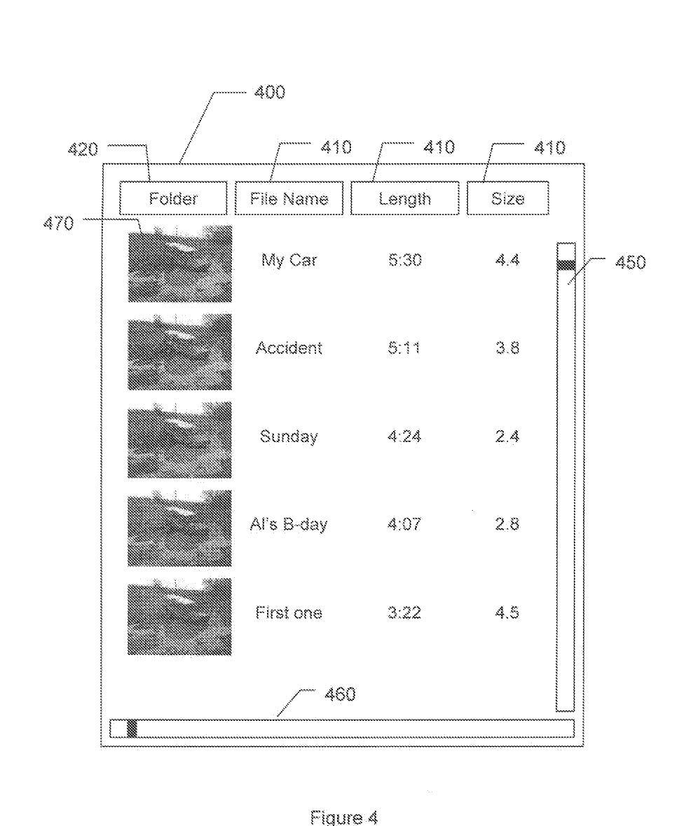

Refer to FIG. 4, which is a diagram illustrating a file upload screen according to an embodiment of the present invention.

After selecting the upload option a file browsing window 400 is displayed and the user selects the file to be uploaded from the available multimedia content 470 stored on their device. The folder name 410 is displayed and the user can navigate through their file system. File information 410 is also provided. The user selects at least one metatag to be associated with the file and the file is uploaded to the user's account. The uploaded file will now show up in lists of multimedia content relevant to the metatags associated with the content or in search result lists and is available for other users to enjoy.

The file format of the uploaded file can be any format playable on an electronic device. Once the file is uploaded the file is transcoded offline. When a user requests a multimedia file the suitable file format for the user's electronic device is streamed to the device. This eliminates incompatibility between the multimedia content and the user's device.

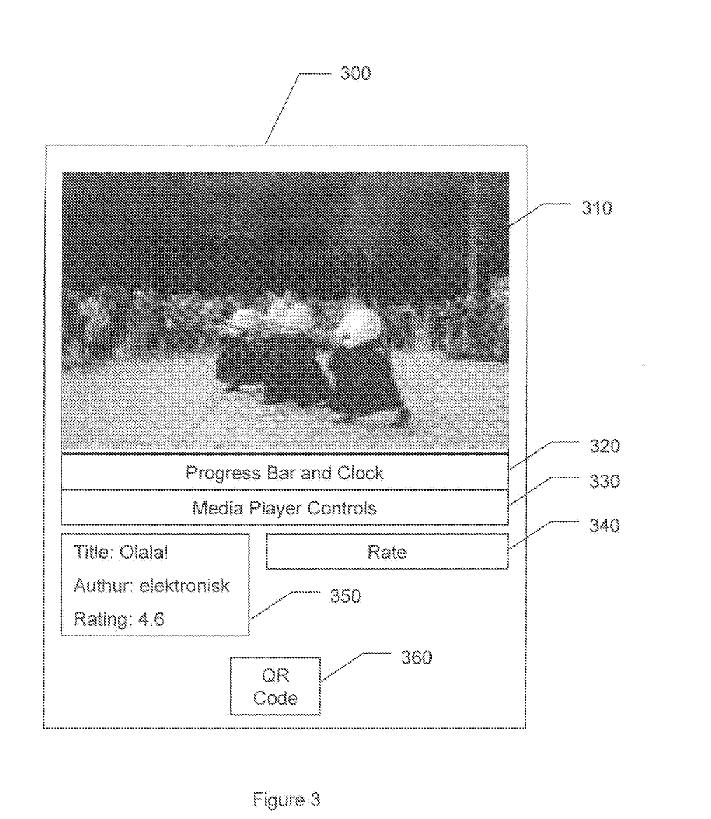

Refer to FIG. 3, which is a diagram illustrating a multimedia player window according to an embodiment of the present invention.

The user selects the content that they wish to view from either the list of multimedia content or the search results list and a media player screen 300 automatically opens and plays the multimedia 310. The player screen 300 provides player controls 330 such as play, pause, fast forward, rewind, stop, next, previous, and save. The save option allows users to store the media locally on their device.

The player controls 300 allow the user to interact with the multimedia 310. A progress bar 320 is displayed showing the progress or how much of the content has been viewed and how much of the content is left. The progress bar 320 also allows the user to jump to a particular section of the content. A clock also displays how much time has expired and how much time is left.

The player screen 300 also displays information 350 associated with the current multimedia. For example, the information comprises title, user name, author, rating, or ranking. A rating option 340 allows the user to vote or rate the multimedia. The current average rating is displayed which is computed from the total votes.

Additionally, a play all option is displayed on the multimedia list screen. This allows the user to automatically play all multimedia content sequentially that are shown in the list.

Also, a full screen option is provided to allow users to view the multimedia content full screen without seeing the information associated with the content.

In an embodiment of the present invention the play screen displays a quick response code (QR Code) 360. The QR Code 360 is a unique graphical code that identifies a particular content file. A QR Code can be printed in tradition media such as in a magazine, advertisement, or newspaper, or displayed on a web page or on television. A user simply photographs the QR Code and QR Code software isolates the code and reads the code to identify the content associated with the particular QR code. A user can then immediately view the content without having to navigate to the location of the stored media.

Additionally, in an embodiment of the present invention, when a user determines that they would like to share a particular content file with another user, the user can simply send the QR Code to the other user and they can now quickly and easily view the content.

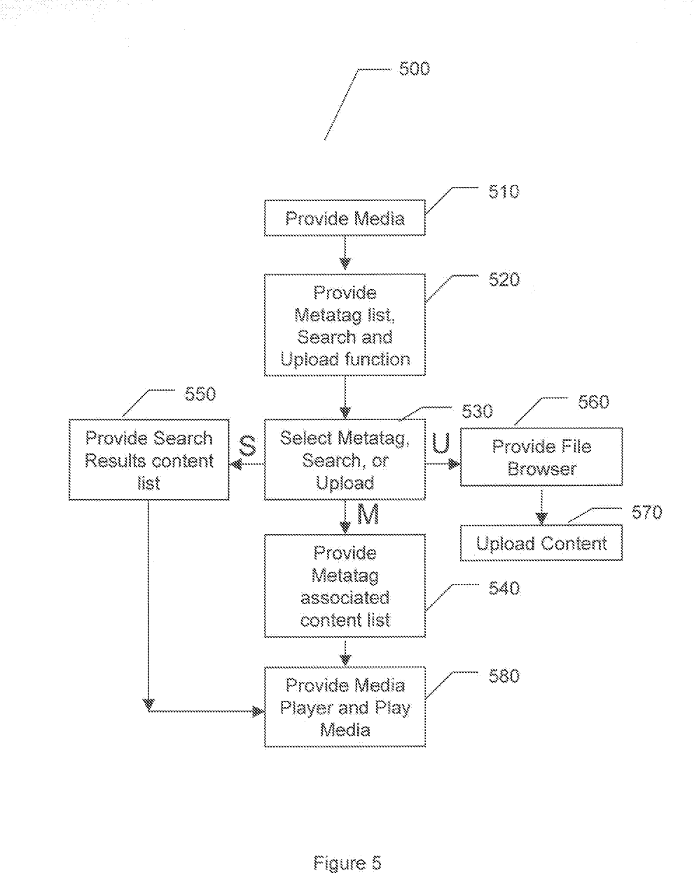

Refer to FIG. 5, which is a flowchart illustrating a method for distributing multimedia content according to an embodiment of the present invention.

The distribution method 500 begins by a content provider providing multimedia content on a content server in Step 510. In Step 520 the content provider provides a list of metatags displayed in a main screen. The metatags are sorted by priority and the amount of content associated with each metatag is visually identifiable by size or color. Also in Step 520 the main screen displays a search option for searching and a text input section for inputting search text. Additionally in Step 520 the main screen displays an upload option for uploading content. Next, in Step 530 a metatag is selected, the search option is selected, or the upload option is selected. If a metatag is selected, a list of multimedia content associated with the selected metatag is displayed in Step 540. If text is input and the search option is selected a list of multimedia content relevant to the search text is displayed in Step 550. If the upload option is selected a file browser is display allowing a user to upload content in Step 560 and content is uploaded in Step 570. When a user selects content from either the search results or the multimedia content list, the content is displayed in a media player window in Step 580.

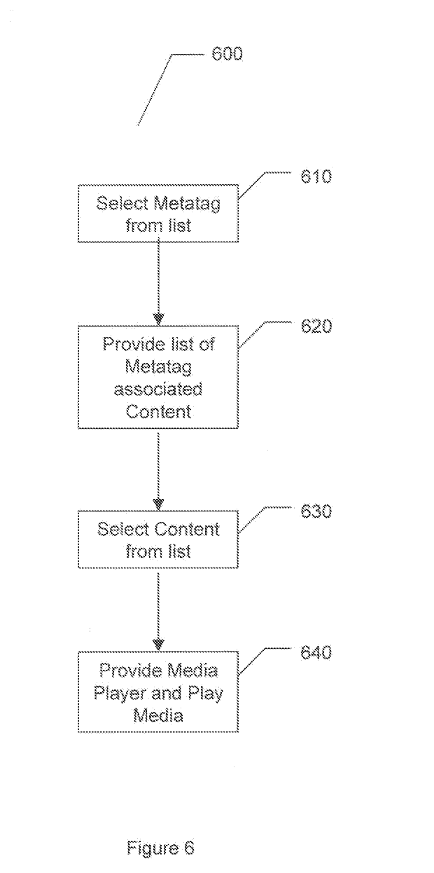

Refer to FIG. 6, which is a flowchart illustrating a method for accessing multimedia content according to an embodiment of the present invention.

The access method 600 begins by selecting a metatag from a list of metatags in Step 610. In Step 620 a list of multimedia content associated with the metatag is displayed. A user then selects the content that they wish to view in Step 630 and a player window opens and plays the multimedia content in Step 640.

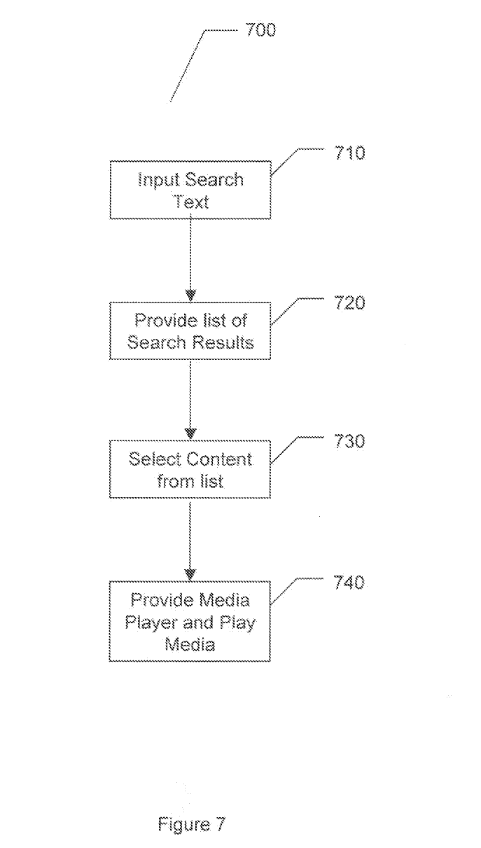

Refer to FIG. 7, which is a flowchart illustrating a method for searching multimedia content according to an embodiment of the present invention.

The search method 700 begins by the user inputting search text and selecting search in Step 710. In Step 720 a list of search results related to the search text is displayed. The user selects content from the list in Step 730. In Step 740 the media player is provided and plays the selected multimedia content.

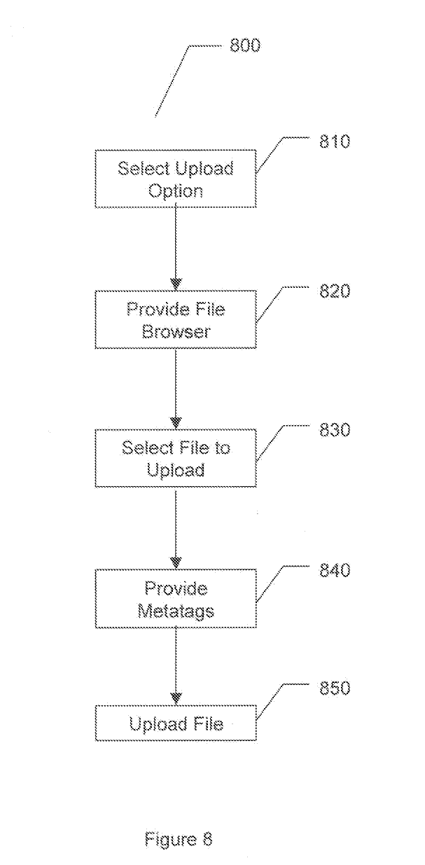

Refer to FIG. 8, which is a flowchart illustrating a method for uploading multimedia content according to an embodiment of the present invention.

The upload method 800 begins by selecting an upload option icon in Step 810 and displaying a file browser in Step 820. After selecting a file for upload in Step 830, inputting a metatag or metatags to be associated with the file in Step 840 the selected file is uploaded to the user's account in Step 850. The file is then made available to other users and is displayed in lists relevant to search results or lists of content associated with the metatag or metatags.

In an embodiment of the present invention, the method is further simplified and comprises a single metatag selection. When a metatag is selected on the main screen the media player window is automatically displayed and all content associated with the selected metatag is played sequentially. This allows users to easily view a large amount of content automatically. The user can simply jump to the next content file or jump to the previous content file if they desire.

For example, if a user selects a metatag “basketball” the player window will begin playing all content associated with the metatag “basketball”. If the user doesn't like the first file they can jump to the next file. In this way the user can quickly locate content they are interested in. The media will play continuously one after the other until the user desires to stop.

In an embodiment of the present invention all the media in the multimedia content list or the search results can be played continuously in a random order.

In another embodiment of the present invention the metatags displayed on the main screen are channels similar to a television channel. In this way the content associated with the metatag is grouped according to a style or format of a particular channel instead of grouped by actual contents of the multimedia. For example, the channel may have a lifestyle format that includes programs about cooking, music, art, interior design and fashion. In other embodiments the metatags would be different for each program. However, in this embodiment a wide variety of content can be enjoyed by the user simply by selecting a particular channel. Channels can be created by individual users similar to a playlist. As a result, a user can establish their own personal broadcasting network.

The mobile electronic device comprises a cellular telephone, portable digital assistant, notebook computer, or portable multimedia player. The protocol to access the content comprises 3G, 3.5G, wi-fi, wi-fly, wi-max, or other wireless or wired protocol. The multimedia content comprises music, movies, video, animation, or games.

It will be apparent to those skilled in the art that various modifications and variations can be made to the present invention without departing from the scope or spirit of the invention. In view of the foregoing, it is intended that the present invention cover modifications and variations of this invention provided they fall within the scope of the invention and its equivalent.

What is claimed is:

1. A method for distributing and accessing multimedia content by a portable electronic device comprising:
providing a metatag list hyperlinking multimedia content associated with each metatag; and
providing a media player that automatically plays all multimedia content associated with a selected metatag.

2. The method for distributing and accessing multimedia content by a portable electronic device of claim 1, the media player playing the multimedia content sequentially.

3. The method for distributing and accessing multimedia content by a portable electronic device of claim 1, the media player playing the multimedia content in a random order.

4. The method for distributing and accessing multimedia content by a portable electronic device of claim 1, the metatags being displayed in a list sorted by number of views.

5. The method for distributing and accessing multimedia content by a portable electronic device of claim 1, a metatag's size indicating amount of content associated with the metatag.

6. The method for distributing and accessing multimedia content by a portable electronic device of claim 1, a metatag's color indicating amount of content associated with the metatag.

7. The method for distributing and accessing multimedia content by a portable electronic device of claim 1, the media player comprising player controls, progress bar, content information, current rating, a rate function, or a combination of these.

8. The method for distributing and accessing multimedia content by a portable electronic device of claim 1, the media player further comprising a unique quick response code that identifies a particular multimedia file.

9. A method for distributing and accessing multimedia content by a portable electronic device comprising:
providing a list of metatags hyperlinking multimedia content associated with one of the metatags;
providing a list of multimedia content associated with a selected metatag; and
providing a media player that plays multimedia content selected from the list of multimedia content.

10. The method for distributing and accessing multimedia content by a portable electronic device of claim 9, further comprising:
providing a search option with text input section for inputting search terms;
providing a list of multimedia content search results relevant to the search terms; and
providing the media player that plays multimedia content selected from the list of search results.

11. The method for distributing and accessing multimedia content by a portable electronic device of claim 9, further comprising:
providing an upload option for uploading multimedia content;
providing a file browser for selecting a multimedia file when the upload option is selected; and
providing an upload function after the multimedia file has been selected to upload the multimedia file to a media server.

12. The method for distributing and accessing multimedia content by a portable electronic device of claim 9, the metatags being displayed in a list sorted by number of views.

13. The method for distributing and accessing multimedia content by a portable electronic device of claim 9, a metatag's size indicating amount of content associated with the metatag.

14. The method for distributing and accessing multimedia content by a portable electronic device of claim 9, a metatag's color indicating amount of content associated with the metatag.

15. The method for distributing and accessing multimedia content by a portable electronic device of claim 9, the list of multimedia content comprising a thumbnail and information of each file.

16. The method for distributing and accessing multimedia content by a portable electronic device of claim 15, the information comprising title, date created, upload user name, number of views, rating, or a combination of these.

17. The method for distributing and accessing multimedia content by a portable electronic device of claim 9, the list of multimedia content being sortable by any information category.

18. The method for distributing and accessing multimedia content by a portable electronic device of claim 9, the list of multimedia content further comprising a play all option that allows all the multimedia content in the list to be played when selected.

19. The method for distributing and accessing multimedia content by a portable electronic device of claim 9, the list of multimedia content further comprising a random option that allows the multimedia content in the list to be played in a random order when selected.

20. The method for distributing and accessing multimedia content by a portable electronic device of claim 9, the media player comprising player controls, progress bar, content information, current rating, a rate function, or a combination of these.

21. The method for distributing and accessing multimedia content by a portable electronic device of claim 20, the media player further comprising a unique quick response code that identifies a particular multimedia file.

22. A method for distributing and accessing multimedia content by a portable electronic device comprising:
providing a list of metatags hyperlinking multimedia content associated with one of the metatags;
providing a list of multimedia content associated with a selected metatag;
providing a media player that plays multimedia content selected from the list of multimedia content;
providing a search option with text input section for inputting search terms;
providing a list of multimedia content search results relevant to the search terms;
providing the media player that plays multimedia content selected from the list of search results;
providing an upload option for uploading multimedia content;
providing a file browser for selecting a multimedia file when the upload option is selected; and
providing an upload function after the multimedia file has been selected to upload the multimedia file to a media server.
